(19) United States
(12) Patent Application Publication
(10) Pub. No.: US 2009/0222345 A1
(43) Pub. Date: Sep. 3, 2009

(54) MANAGING AUCTION SIZE FOR ACTIVITY-BASED ADVERTISING

(75) Inventor: Daniel H. Greene, Sunnyvale, CA (US)

Correspondence Address: PVF -- PARC;c/o PARK, VAUGHAN & FLEMING LLP, 2820 FIFTH STREET, DAVIS, CA, 95618-7759, US

(73) Assignee: PALO ALTO RESEARCH CENTER INCORPORATED, Palo Alto, CA (US)

(21) Appl. No.: 12/062,823

(22) Filed: Apr. 4, 2008

Related U.S. Application Data
(60) Provisional application No. 61/032,421, filed on Feb. 28, 2008.

(51) Int. Cl. G06Q 30/00

(52) U.S. Cl. 705/14

(57) ABSTRACT

One embodiment of the present invention provides a system that manages auction size in an activity-based advertising system. During operation, the system identifies a topic and determines a set of auction criteria. The system then hosts an auction for advertisements pertaining to the topic. The system determines the quality of auction size and manages the auction size by modifying the auction criteria. The system then presents the advertisements based on the winning bids.

### RELATED APPLICATIONS

This application claims priority under 35 U.S.C. section 119(e) to U.S. Provisional Application Ser. No. 61/032,421, filed on Feb. 28, 2008, the contents of which are herein incorporated by reference.

This application is related to pending US patent application “Receptive Opportunity Presentation of Activity-Based Advertising,” Attorney Docket Number PARC-20071055-US-NP, filed 4 Apr. 2008; US patent application “Incentive Mechanism for Developing Activity-Based Triggers of Advertisement Presentation,” Attorney Docket Number PARC-20071057, filed 4 Apr. 2008; US patent application “Identifying Indeterminacy for Activity-Based Advertising,” Attorney Docket Number PARC-20071058, filed 4 Apr. 2008; and US patent application “Advertising Payment Based on Confirmed Activity Prediction,” Attorney Docket Number PARC-20071059, filed 4 Apr. 2008.

### BACKGROUND

This disclosure generally relates to advertising systems. In particular, this disclosure relates to an activity-based advertising system that manages its auction size.

The ubiquitous Internet connectivity coupled with wide deployment of wireless devices is drastically changing the advertising industry. Of the $385 billion spent globally on advertising in 2005, online and wireless spending accounted for $19 billion. Internet advertising was the fastest-growing form of advertisement, with a cumulative annual growth rate of 18.1 percent. However, Internet advertising has its limitations, and new opportunities remain to be discovered to sustain the dramatic rate of growth in new media advertising. Existing Internet advertisements only work when a user is online and watching a computer screen. Traditional advertising, in contrast, comes in many forms. For example, signs can advertise products inside retail stores. Radio programs can advertise products when the listener engages in a wide variety of activities. Printed advertisements can appear anywhere paper is used, from newspapers, to flyers, receipts, and ticket stubs. Although Internet advertising surpasses traditional advertising in its ability to better target consumer interest, it still cannot be closely tailored to human activities.

Internet-based advertisers typically employ an auction system, wherein advertisers bid for advertising opportunities. For these systems, sustaining a healthy auction size is critically important to the commercial viability of the advertising service provider.

### BRIEF DESCRIPTION OF THE FIGURES

The disclosure herein is illustrated by way of example, and not by way of limitation, in the figures of the accompanying drawings and in which like reference numerals refer to similar elements.

FIG. 1 illustrates an exemplary architecture for a receptive-opportunity-based advertising system, in accordance with an embodiment of the present invention.

FIG. 2 presents a block diagram illustrating an exemplary mode of operation of a receptive-opportunity-based advertising system, in accordance with an embodiment of the present invention.

FIG. 3 presents a block diagram illustrating the auction process in a receptive-opportunity-based advertising system, in accordance with an embodiment of the present invention.

FIG. 4 presents a flowchart illustrating the process of auctioning receptive opportunities to advertisers, in accordance with an embodiment of the present invention.

FIG. 5 presents a flowchart illustrating the process of managing auction size in a receptive-opportunity-based advertising system, in accordance with an embodiment of the present invention.

FIG. 6 illustrates an exemplary computer system that facilitates an advertising system based on receptive opportunities, in accordance with an embodiment of the present invention.

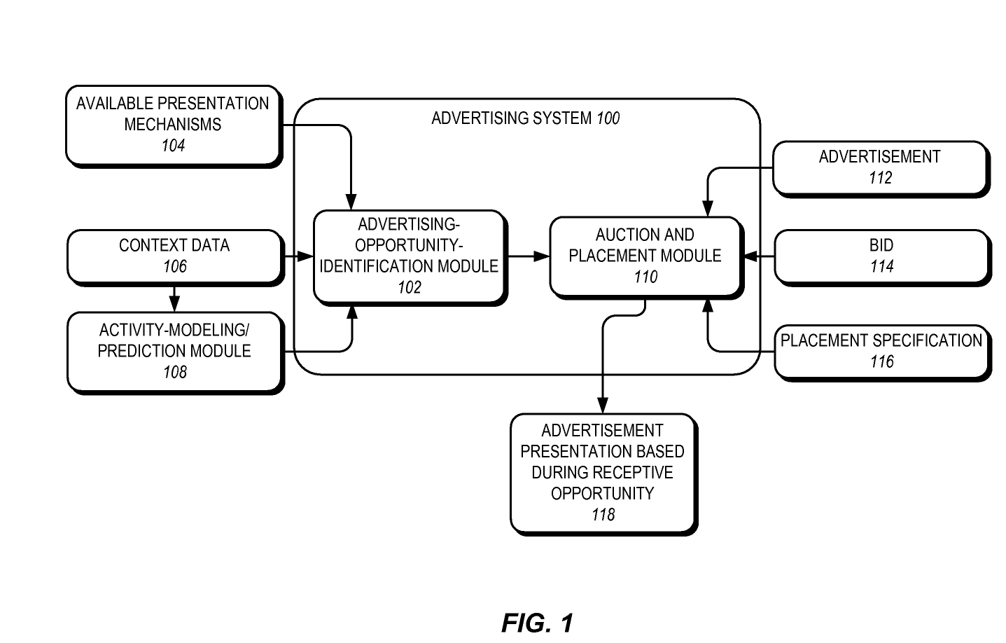

In the drawings, the same reference numbers identify identical or substantially similar elements or acts. The most significant digit or digits in a reference number refer to the figure number in which that element is first introduced. For example, element 102 is first introduced in and discussed in conjunction with FIG. 1.

### SUMMARY

One embodiment of the present invention provides a system that manages auction size in an activity-based advertising system. During operation, the system identifies a topic and determines a set of auction criteria associated with the topic. The system then hosts an auction for advertisements pertaining to the topic. In response to the auction, the system receives a number of bids wherein a respective bid is associated with an advertisement and a set of presentation preferences, and wherein a respective bid satisfies the auction criteria. The system then determines the quality of auction size and manages the auction size by modifying the auction criteria. The system then presents the advertisements based on the winning bids.

In a variation of this embodiment, determining the quality of auction size involves performing one or more of: determining the number of participants in the auction, determining the consistency of participation in the auction, determining the distribution of bids with respect to each bid's presentation preference and the auction criteria, and determining the number of repeated participations of the a winning bidder.

In a variation of this embodiment, the auction criteria specify the constraints on the advertisements to be presented by indicating one or more of: a time window, a time of day, a day of week, a weather condition, a range of location, and an activity.

In a variation of this embodiment, managing the auction size involves: increasing the auction size when the number of participants in the auction is below a predetermined lower limit, or reducing the auction size when the number of participants in the auction is greater than a predetermined upper limit.

In a variation of this embodiment, managing the auction size involves increasing the auction size by performing one or more of the following operations to the auction criteria: increasing the size of a time window, increasing a range of location, and dropping a constraint from the criteria.

In a variation of this embodiment, managing the auction size involves reducing the auction size by performing one or more of the following operations to the auction criteria: reducing the size of a time window, reducing a range of location, and adding a constraint from the criteria.

In a variation of this embodiment, the system modifies the auction criteria based on the presentation preferences specified in a bid.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Receptive-Opportunity-Based Advertising System

Embodiments of the present invention provide an advertising system that presents advertisements based on receptive opportunities with respect to a customer's activities. The system auctions the receptive opportunities to advertisers, and manages the auction size to maintain a substantially optimal number of participating bidders. In one embodiment, the system targets advertising to mobile customers (e.g., via cell phones, personal digital assistants (PDAs), and in some cases nearby electronic billboards). The system determines the current activity of the customer, and, when appropriate, delivers activity-targeted advertising that can influence the customer's future purchase behavior. For example, the system might deliver an advertisement for a nearby restaurant to a customer's cell phone at just the time the customer is deciding where to have dinner. In general, system assesses the customer's current contexts, predicts the customer's future decisions (e.g., that the customer usually visits a restaurant after leaving the train), identifies good opportunities to present the advertising (e.g., while the customer is waiting for the train), and presents the customer with relevant and useful advertising.

Embodiments of the present invention can be considered as the juncture of computer science and economics. In particular, the advertising system described herein couples the decision mechanisms—which determine when, where, and how to deliver advertising—with the business models and economic mechanisms that create the right incentives for all parties using the system. Note that, without losing generality, the parties using the system can be (1) the customers, (2) the advertisers, and (3) the operator of the system functioning as a broker of advertising opportunities between advertisers and customers, which is referred to as “advertising provider” or “provider” in this disclosure. This integrated approach involves linking the decision mechanisms that analyze a customer's activity to an auction mechanism that allows advertisers to compete to present advertisements to customers.

This disclosure uses the following terminologies:

Advertiser. This term typically refers to a company wishing to advertise its service or products. This disclosure uses the terms “advertiser” and “advertisement broadly to refer to content provider and content, where, for example, the content provider is willing to pay to have targeted content delivered to customers, even if that content does not advertise a specific service or product. The typical advertiser would like to maximize profit, where advertising is one of the costs. For this reason, well targeted advertising is more effective for advertisers. In this disclosure, an advertiser is also referred to as a “participant” or “bidder” in an auction.

Customer. This term refers to a recipient of the advertising—a potential customer of the advertisers. Customers typically welcome some advertisements but prefer not to receive other kinds of advertisements. For this reason, well targeted advertising is more acceptable for customers. This disclosure uses the term “customer” broadly to include people who receive content, even if that content is not meant to include to the person as a customer of the advertiser.

Provider. This term refers to the provider of the service that delivers advertisements to customers. The provider is responsible for delivering well targeted advertising. Embodiments of the present invention provide the technology that a provider can use to deliver advertisements based on a customer's activity and context. In some embodiments, there can be a separate publisher who provides the channels for presentation to the customer. The provider can choose the advertisements and the publisher's channel, and, depending on the payment mechanism, charges the advertiser and rewards the publisher.

Presentation. This term refers to the showing of an advertisement to a customer. Note that embodiments of the present invention are independent from the form of the presentation. Presentation might include adding a banner or pop-up to a PDA or cell phone, playing an audio message by phone, music player, or car stereo, modifying a map on a GPS navigation device, or changing a billboard near the customer.

Payment. This term refers to the amount an advertiser pays the provider after a “successful” presentation. Successful presentations can be defined in many different ways. Correspondingly, the payment can also be structured differently. It could be pay-per-presentation, pay-per-click, or pay-per-action (a form of commission defined by the advertiser). In one embodiment, a new pay-per-confirmed-prediction payment structure is used for activity-based advertising.

Activity. This term refers to the activity of the customer. For example, a customer's activity might be “walking towards a train station.” The activity can be described at different semantic levels. For example, “walking towards a train station” might also be described as “commuting home after work.” In the advertising system in accordance with some embodiments, the activity may be partially described with objectives, such as “to obtain exercise,” tools, such as “with a bicycle,” skill levels, such as “expert,” and other modifiers/qualifiers of the activity. Activity-targeting or activity-based advertising may rely on complete or partial descriptions on different semantic levels to facilitate reaching large numbers of relevant activities.

Context. This term refers to additional information surrounding the customer's activity. For example, the activity might be occurring on a rainy day. In some embodiments, both the activity description and the context description are used for activity-based presentation of advertisements. Note that the term “context” if often used in conjunction with terms related to activities. The terms “activity,” “activity targeting,” and “activity-based advertising” are typically used in a way that involves features of the activity as well as possible additional context for targeting the advertising.

In some embodiments of the present invention, the presentation of activity-based advertising involves both topic and opportunity. For example, the topic can be baseball merchandise for baseball fans, while the opportunity can be vehicles stopped in traffic jam leaving the baseball stadium. For another example, the topic can be restaurants in Yokohama, while the opportunity can be waiting for a train in the Tokyo station. In conventional keyword-search-based advertising, the topic is determined by the user's inputted keyword(s), and the opportunity is the time of the search query. However, in activity-based advertising, there may be separation between the identification of the topic and the identification of the opportunity. The identification of the topic can be inferred from an activity, such as watching a baseball game. Other context can be used in identifying the topic, and the topic can be based on a predicted future activity. Likewise, the identification of opportunity can be based on a variety of information, including but not limited to: (1) inferred activity, such as waiting in a traffic jam, (2) other context, such as the customer is with friends, and/or (3) the availability of channels for advertising presentation.

Embodiments of the present invention use a factored approach to auction the advertising opportunities, where advertisers bid first on topics, optionally with some broad constraints about the opportunity, and then the provider uses a selection mechanism to determine the opportunities used to make the presentations. This factored approach simplifies the bidding for advertisers and increases the flexibility of providers to manage the presentation of advertisements.

The factored approach works as follows: advertisers first bid on certain topics. The topics can be determined by the providers or advertisers, and the defined categories of similar advertising targets for which advertisers compete. In this phase, the advertisers compete primarily with other advertisers interested in the same topic. Their bids do not specify the exact presentation opportunity, except in broad terms, e.g., within a three-hour window, within a certain distance of home, etc.

The provider selects the winning bidders. Their advertisements become pending presentations. The provider then looks for presentation opportunities. Good opportunities include instances such as idle time, traffic jams, the time a customer spends traveling on trains and buses, browsing the web on a PDA, reading e-mail on a cell phone, or strolling in a park. The provider manages these opportunities. Note that the customer does not always receive advertisements during such times, because the provider may want to protect the valuable attention of the customer. When an opportunity is used, there may be a variety of pending presentations from different topics. The provider can select the pending presentations based on criteria such as: time since (or time before) activity used to infer topic, previous success of similar topics in similar opportunities, size of bid, expected revenue, customer preferences, and/or previous success with the customer. In selecting the pending presentations, the provider may strive to deliver a mixture of topics and experiment to learn what the customer wants. Using criteria such as those mentioned above, the provider may rank the pending presentations, effectively causing them to compete a second time for an opportunity.

FIG. 1 illustrates an exemplary architecture for a receptive-opportunity-based advertising system, in accordance with an embodiment of the present invention. In one embodiment, an advertising system 100 includes two modules, an advertising-opportunity-identification module 102 and an auction and placement module 110. Advertising-opportunity-identification module 102 is in communication with available presentation mechanisms 104 and receives context data 106 which indicates the current context the customer is in. In addition, advertising-opportunity-identification module 102 is also in communication with an activity-modeling/prediction module 108, which predicts or derives the customer's activities. Based on the received information, advertising-opportunity-identification module 102 identifies a receptive opportunity for presenting advertisements.

In one embodiment, presentation mechanisms 104 can include a variety of devices that can present an advertisement. Such devices can include a mobile phone, PDA, computer, public display, radio, TV, in-vehicle navigation system, etc.

Context data 106 can include different types of information that can be used to determine the customer's past, current, or future activities. Such information can include physical information such as time of day, day of week, weather condition, the customer's location, speed of motion, etc. Context data 106 can also include logical contents pertaining to the customer, such as the content of the customer's calendar, instant messages, and emails, history of the customer's past activities, and the customer's previous response to advertisements. In one embodiment, context data 106 can be collected by a mobile device, such as a cell phone, carried by the customer.

In one embodiment, activity-modeling/prediction module 108 uses context data 106 to derive past, current, and/or future activities associated with a customer. For example, the customer's cell phone can be equipped with a GPS. Based on pre-stored venue information and the traces of the customer's locations at different times, activity-modeling/prediction module 108 can determine that at a certain time of day the customer typically engages in a particular activity.

In one embodiment, activity-modeling/prediction module 108 analyzes context data 106 to determine the customer's current activity and predict the customer's future activity. Based on this activity information, context data 106, and information about available presentation mechanisms 104 which are in the vicinity of the customer (e.g., the customer's cell phone or a dynamic billboard close to the customer), advertising-opportunity-identification module 102 identifies suitable receptive opportunities for advertising. For example, the system might identify an activity of “eat” when a customer is waiting on a platform for a commuter train, and has not yet had dinner. Correspondingly, advertising-opportunity-identification module 102 produces an opportunity description, which can include the time, presentation mechanism, and topic (which corresponds to the identified activity) for advertisements.

Note that activity-modeling/prediction module 108 can reside on the customer's mobile device or on a remote server. Similarly, advertising-opportunity-identification module 102 can reside on a customer's mobile device or on a remote server.

Once good advertising opportunities are identified, the system then determines a relevant advertisement to present. In one embodiment, the system brokers the presentation opportunities to the appropriate advertisers by using a factored process to select advertisers for an identified opportunity. The system first allows advertisers to bid for advertising opportunities with respect to a topic. Based on the bids, the system selects a number of top bids as pending presentations for that topic. Next, when a receptive opportunity is identified, the system selects from all the pending presentations under different topics the presentations to place in the opportunity.

Note that although some pending presentations may be the highest-ranking bids in their respective topic group, the system may not select those presentations for a given advertising opportunity if the presentation's topic does not match with the opportunity. For example, when the system determines that a customer has just been to a restaurant and is now waiting for a train on his way home, it would be a good opportunity to advertise for entertainment-related products, but a poor opportunity to advertise for restaurant or food. In the example illustrated in FIG. 1, auction and placement module 110 receives an advertisement 112, a corresponding bid 114, and corresponding placement specification 116 from an advertiser. The bidding advertiser can use placement specification 116 to request certain conditions for placing advertisement 112, such as time window, target audience, targeted activity, a customer's indeterminacy, and/or the presentation opportunity. Auction and placement module 110 then ranks the bids for each topic, and selects a number of highest bids for each topic as pending presentations.

Subsequently, after receiving an opportunity description from advertising-opportunity-identification module 102, auction and placement module 110 selects one or more pending presentations 118 to be placed during the receptive opportunity. In one embodiment, the selection of presentations to be placed during the opportunity is based on an optimization algorithm which takes into account a number of factors. For example, auction and placement module 110 chooses from the pending presentations according to one or more of:

1. Size of the advertiser's bid. This will increase the revenue to the provider, and will tend to select the more relevant advertisements for the customer.

2. Time of the opportunity relative to the topic activity. This allows the provider to lower the weighting of activities further ahead or further behind the present activity.

3. The mix of topics being presented to the customer.

4. Past experience with the customer. (This may already be included in the topic. For example, the advertisers may bid for customers whose activity indicates that they have previously accepted recommendations.)

5. Experimentation.

In general, any criteria that will help predict the success of the presentation can be used by the provider to select pending presentations. In one embodiment, the provider can also adjust the charge to an advertiser according to the quality of the receptive opportunity. For example, the advertiser bids on a topic, assuming an “ideal” quality presentation, but the provider may give the advertiser a discount according to some of the criteria listed above.

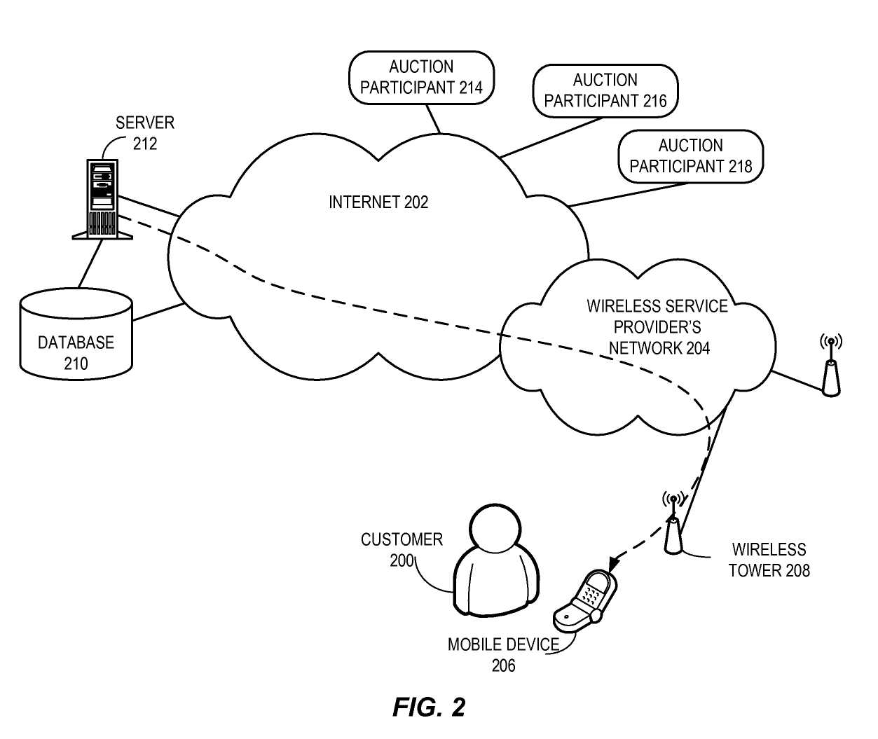

FIG. 2 presents a block diagram illustrating an exemplary mode of operation of a receptive-opportunity-based advertising system, in accordance with an embodiment of the present invention. In this example, a customer 200 uses a mobile device 206, which can be a smart phone. Mobile device 206 is in communication with server 212 via a wireless tower 208, a wireless service provider's network 204 and the Internet 202. During operation, mobile device 206 collects a set of context data, such as customer 200's calendar content, the GPS trace of the places he has been to, the current time, etc., and determines the current or future activity for customer 200. For example, mobile device 206 can detect that it is now 6 μm, customer 200 has just left from the office, and that he is currently at a train station. From previously collected data, mobile device 206 also learns that customer 200 typically visits a restaurant after the train ride. Based on this information, mobile device 206 determines that the next 15 minutes would be a good receptive opportunity to present advertisements for restaurants and bars. Correspondingly, mobile device 206 communicates this opportunity description, which in one embodiment includes at least the topics and a time window, to server 212.

In response, server 212 retrieves from database 210 bids whose placement specification indicates that they are appropriate for the activity, customer indeterminacy, and/or the receptive opportunity, and selects the winning advertisements. Note that this selection process can be configured to meet the provider's needs. For example, the provider can select presentations with the highest bid for the topics associated with the opportunity description, or the presentations that are the closest match to the customer needs. In one embodiment, server 212 can also compute a discount to the advertiser based on the predicted quality of the opportunity with respect to the presentation.

Server 212 then communicates the advertisements and instructions on how to present these advertisements to mobile device 206. In one embodiment, the advertisements can be streamed video, audio, graphics, text, or a combination of above. After receiving the advertisements, mobile device 206 presents these advertisements based on the instructions. Note that other presentation mechanism can also be used. For example, the presentation mechanism can be a nearby LCD display installed in the train. The LCD display can be equipped with some communication mechanism, such as Bluetooth, to communicate with mobile device 206. During the presentation, mobile device 206 can stream the advertisements to the LCD display, so that customer 200 can view the advertisements more easily on a bigger screen.

### Auction-Size Management

In an activity-based advertising system, auction size (which is partly indicated by the number of participants in the auction) is critical to the success of the system. If the auctions are too small, then presentation opportunities can be won for small payments. While this may appear to be beneficial to the advertisers, it will likely allow poorly targeted advertising to win auctions and be presented to customers. Too much poorly targeted advertising will alienate customers and reduce the effectiveness of the system for all parties—the advertisers, customers, and the provider. Small payments can also diminish the economic return to the provider. The provider, who runs the auctions, has a strong incentive to create vigorous competition in the auctions.

On the other hand, overly large auctions are also undesirable, because they can result in the “winner's curse” phenomenon, where a winning bidder overpays for an advertisement opportunity. The winner's curse occurs when a winning bidder of a large auction has likely misunderstood the value of the item (which in this case is the advertisement opportunity), and pays too much for the item. While this phenomenon seems to benefit the provider, the provider has a long-term objective to help advertisers succeed with the system. If advertisers frequently overpays for opportunities, they will eventually become frustrated with the results and cease using activity-based advertising for their business.

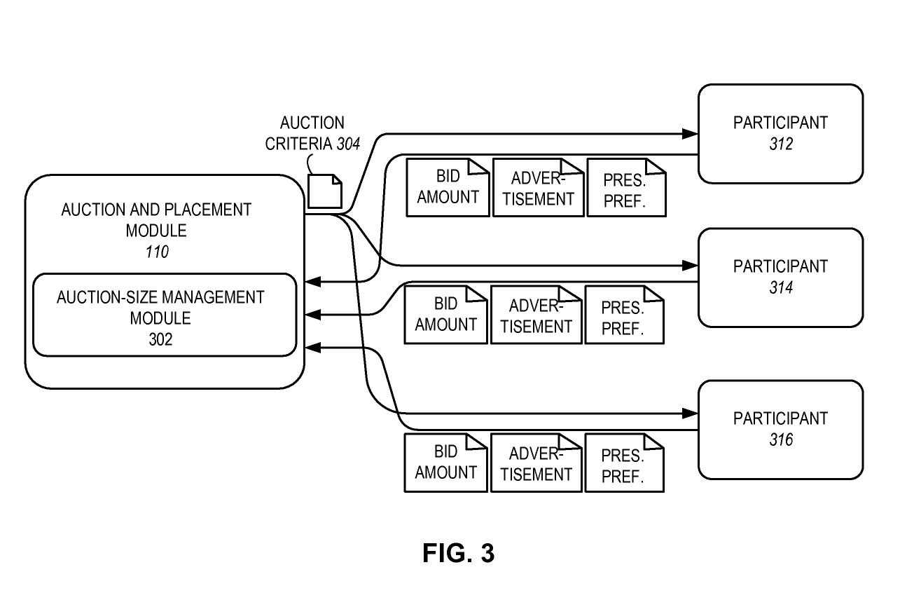

In one embodiment, the advertising system controls the size of an auction by adjusting a set of auction criteria. FIG. 3 presents a block diagram illustrating the auction process in a receptive-opportunity-based advertising system, in accordance with an embodiment of the present invention. Auction and placement module 110 includes an auction-size management module 302. During an auction, auction and placement module 110 broadcasts a set of auction criteria 304 to participants 312, 314, and 316. Auction criteria 304 typically describe the advertising opportunity which may be identified in the future for placing an advertisement. For example, auction criteria 304 can specify a time window, a time of day, a day of week, a weather condition, a location range, and a customer activity for an advertisement opportunity. In general, the more specific auction criteria 304 are, the smaller the auction size is likely to be, because fewer advertisements can satisfy auction criteria 304. Furthermore, when auction criteria 304 are more restrictive, fewer participants will want the exact same advertisement-placement conditions and the auction will be more likely to be small.

In the example in FIG. 3, after receiving auction criteria 304, participants 312, 314, and 316 each transmit back to auction and placement module 110 their respective bid amount, advertisement, and a set of presentation preferences expressed using the auction criteria. The bid amount is the amount of payment a respective participant is willing to pay for an opportunity. The advertisement is the content to be presented to a customer. The presentation preferences indicate under which conditions the advertiser would like its advertisement to be presented (e.g., time frame, location, etc.). Based on the bids and associated information received from the participants, auction and placement module 110 then selects a number of bids to be the pending presentations. When an opportunity is identified, auction and placement module 110 and a customer's mobile device jointly present the pending presentations to the customer.

In one embodiment, auction-size management module 302 monitors the quality of the auction size over multiple auctions, and manages the auction size by modifying auction criteria 304. In one embodiment, auction-size management module 302 adjusts the granularity of auction criteria 304 in terms of time and/or location, thereby effectively changing the size of the auction. In this way, the system can manage the auction size while still being able to cater to the interests of the advertisers. As a result, auction-size management module 302 enables the provider to solve the problems associated with overly small or large auctions, and to attain a healthy auction size to the benefit of the advertiser, provider, and customer.

By contrast, search-based advertising handles the auction size issue differently. With most search queries using only a few terms, there are not as many different auctions. The lightly populated auctions (which are typically associated with less frequent search logics) are used as an attraction for new advertisers, with the expectation that eventually these auctions will grow large enough for vigorous competition. Unfortunately, many keyword combinations have grown too large and too competitive to be valuable to advertisers. Activity-based advertising, with the capability of managing auction size, can better serve the business needs of advertisers.

In one embodiment, the system manages the auction size with a control loop, in which the system evaluates the quality of the current auction size and then adjusts the auction size by changing the criteria used to define the auction. The system evaluates the quality of the current auction size based on one or more of the following observations:

1. The number of participants in an auction.

2. The consistency of participation, which indicates how often a participant participates in recurring auctions.

3. The distribution of bids with respect to each bid's presentation preference and the auction criteria.

4. The number of repeated participations of the winning bidder.

Based on past observations, the system may estimate an empirical near-optimal auction-size range. For example, the system may determine that a healthy auction has a size of a moderate number of participants (e.g., 10-20) with repeated participation, especially by the winning bidders. Then, when the current auction's size is below or above the near-optimal range, the system can modify the auction criteria so that the auction size will fall into the near-optimal range.

In one embodiment, the system can adjust the current auction size by one or more of the follow methods:

1. Increasing or reducing the size of a time window in one or more of the criteria.

2. Increasing or reducing a range of location in one or more of the criteria.

3. Adding or dropping one or more constraints in the criteria.

In some embodiments, the system can also modify a set of auction criteria based on the presentation preferences specified by an advertiser. For example, an advertiser can first specify the following presentation preferences:

time of presentation: between 11 am and 12 am;

motion: customer predicted to be traveling towards the shopping center;

location: within 1 km of the shopping center; and

weather: sunny.

In response, the provider's system might counter with a set of less restrictive auction criteria:

time of presentation: between 10 am and 12 am;

motion: customer predicted to be traveling towards the shopping center;

location: within 2 km of the shopping center; and

weather: any.

If these less restricted criteria are acceptable to the advertiser, the advertiser can bid in this larger auction. The initial presentation preferences specified by the advertiser are recorded, so that the provider's system can use this information later to reduce the auction size when the auction becomes too large.

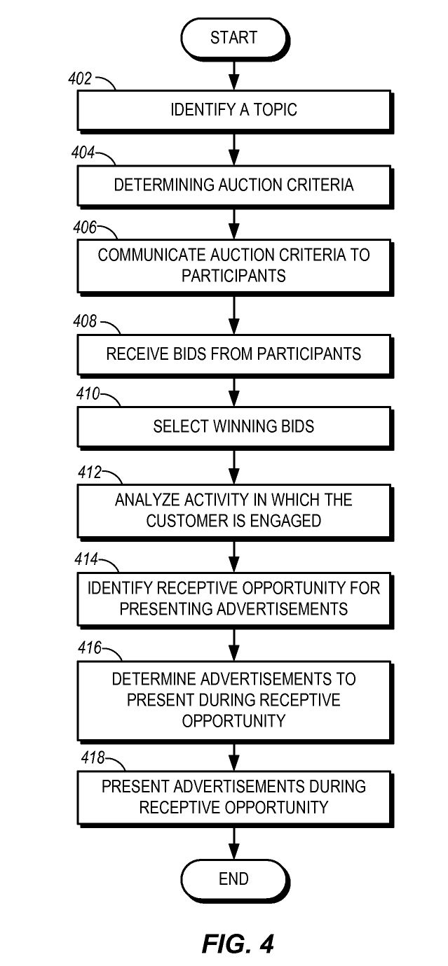

FIG. 4 presents a flowchart illustrating the process of auctioning receptive opportunities to advertisers, in accordance with an embodiment of the present invention. During operation, the system identifies a topic (operation 402). The system then determines a set of auction criteria for the identified topic (operation 404). Subsequently, the system communicates the auction criteria to a number of participants (operation 406). Note that the system can broadcast the auction criteria over the Internet to a predetermined group of participants. Alternatively, the system can publish the auction criteria on the Internet and allow any advertiser to bid in the auction.

In response to the published auction criteria, the system receives a number of bids from the participants (operation 408). The system then selects the winning bids to be pending presentations (operation 410). The system further analyzes activity in which a customer is engaged (operation 412). Based on the analysis, the system identifies a receptive opportunity for presenting advertisements (operation 414). Next, the system determines the advertisements to present during the receptive opportunity (operation 416). The system then presents the chosen advertisements during the receptive opportunity (operation 418).

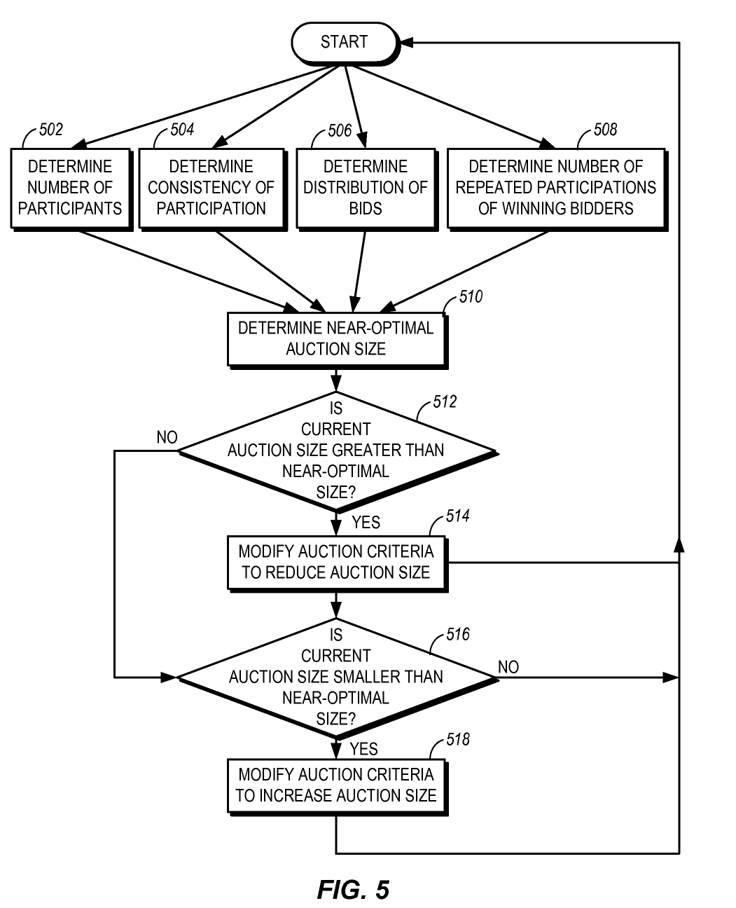

FIG. 5 presents a flowchart illustrating the process of managing auction size in a receptive-opportunity-based advertising system, in accordance with an embodiment of the present invention. During operation, the system performs four observations in the current auction as well as past auctions: the system determines the number of participants in a given auction (operation 502); the system determines the consistency of participation over a number of auctions (operation 504); the system determines the distribution of bids with respect to auction criteria in a given auction (operation 506); and the system determines the number of repeated participations of winning bidders over a number of auctions (operation 508). In one embodiment, the system can make these four observations in parallel.

Based on these observations, the system then determines a near-optimal auction size, which in one embodiment can be a size range (operation 510). The system then determines whether the current auction size is greater than the near-optimal size (operation 512). If so, the system modifies the auction criteria to reduce the auction size (operation 514) and then proceeds with the current auction. Otherwise, the system further determines whether the current auction size is smaller than near-optimal size (operation 516). If so, the system modifies the auction criteria to increase the auction size (operation 518). Otherwise, the future proceeds with the current auction.

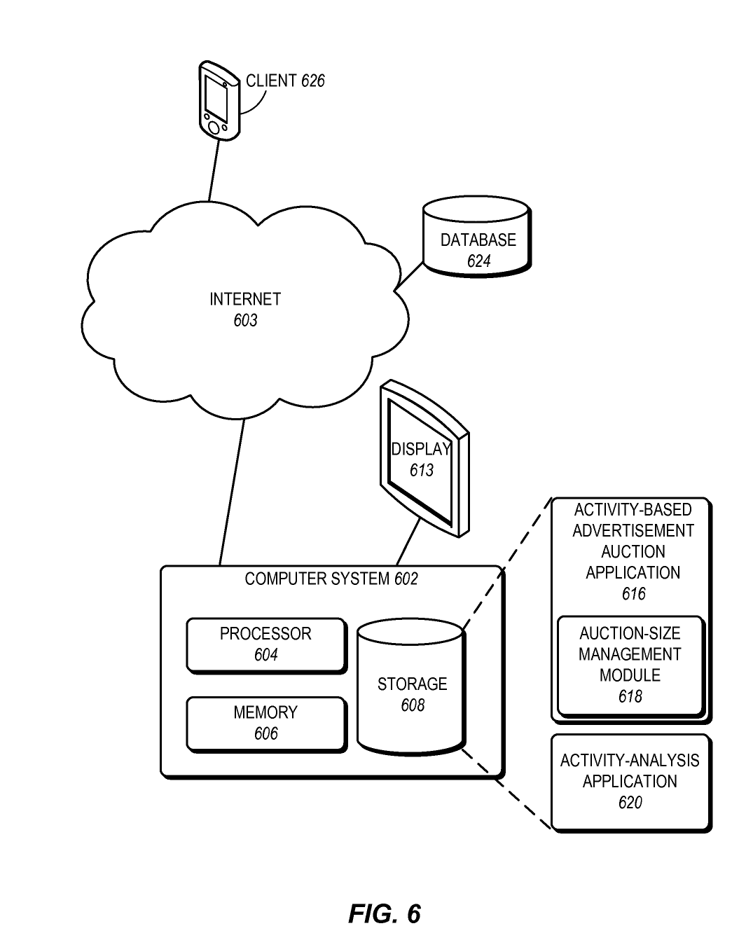

FIG. 6 illustrates an exemplary computer system that facilitates an advertising system based on receptive opportunities, in accordance with an embodiment of the present invention. In this example, computer system 602 performs the functions of a provider. Via Internet 603, computer system 602 is in communication with a database 624 and a client 626, which in one embodiment can be a PDA or cell phone.

Computer system 602 can include a processor 604, a memory 606, and storage device 608. In one embodiment, computer system 602 is coupled to a display 613. Storage device 608 stores an activity-based advertisement auction application 616, and an activity-analysis application 620. Activity-based advertisement auction application 616 includes an auction-size management module 618. During operation, activity-based advertisement auction application 616 and activity-analysis application 620 are loaded from storage device 608 into memory 606, and executed by processor 604. Accordingly, processor 604 performs the aforementioned functions to facilitate auction-size management.

The foregoing descriptions of embodiments described herein have been presented only for purposes of illustration and description. They are not intended to be exhaustive or to limit the embodiments to the forms disclosed. Accordingly, many modifications and variations will be apparent to practitioners skilled in the art.

The methods and processes described in the detailed description section can be embodied as code and/or data, which can be stored in a computer-readable storage medium as described above. When a computer system reads and executes the code and/or data stored on the computer-readable storage medium, the computer system perform the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field programmable gate arrays (FPGAs), and other programmable-logic devices now known or later developed. When the hardware modules are activated, the hardware modules perform the methods and processes included within the hardware modules.

What is claimed is:

1. A computer implemented method for managing auction size in an activity-based advertising system, the method comprising:
identifying a topic;
determining a set of auction criteria associated with the topic;
hosting an auction for advertisements pertaining to the topic;
receiving a number of bids in response to the auction, wherein a respective bid is associated with an advertisement and a set of presentation preferences, and wherein a respective bid satisfies the auction criteria;
determining the quality of auction size;
managing the auction size by modifying the auction criteria; and
presenting the advertisements based on the winning bids.

2. The method of claim 1, wherein determining the quality of auction size comprises performing one or more of:
determining the number of participants in the auction;
determining the consistency of participation in the auction;
determining the distribution of bids with respect to each bid's presentation preference and the auction criteria; and
determining the number of repeated participations of the a winning bidder.

3. The method of claim 1, wherein the auction criteria specify the constraints on the advertisements to be presented by indicating one or more of:
a time window;
a time of day;
a day of week;
a weather condition;
a range of location; and
an activity.

4. The method of claim 1, wherein managing the auction size comprises:
increasing the auction size when the number of participants in the auction is below a predetermined lower limit; or
reducing the auction size when the number of participants in the auction is greater than a predetermined upper limit.

5. The method of claim 1, wherein managing the auction size comprises increasing the auction size by performing one or more of the following operations to the auction criteria:
increasing the size of a time window;
increasing a range of location; and
dropping a constraint from the criteria.

6. The method of claim 1, wherein managing the auction size comprises reducing the auction size by performing one or more of the following operations to the auction criteria:
reducing the size of a time window;
reducing a range of location; and
adding a constraint from the criteria.

7. The method of claim 1, further comprising modifying the auction criteria based on the presentation preferences specified in a bid.

8. A computer-readable medium storing instructions which when executed by a computer cause the computer to perform a method for managing auction size in an activity-based advertising system, the method comprising:
identifying a topic;
determining a set of auction criteria associated with the topic;
hosting an auction for advertisements pertaining to the topic;
receiving a number of bids in response to the auction, wherein a respective bid is associated with an advertisement and a set of presentation preferences, and wherein a respective bid satisfies the auction criteria;
determining the quality of auction size;
managing the auction size by modifying the auction criteria; and
presenting the advertisements based on the winning bids.

9. The computer-readable medium of claim 8, wherein determining the quality of auction size comprises performing one or more of:
determining the number of participants in the auction;
determining the consistency of participation in the auction;
determining the distribution of bids with respect to each bid's presentation preference and the auction criteria; and
determining the number of repeated participations of the a winning bidder.

10. The computer-readable medium of claim 8, wherein the auction criteria specify the constraints on the advertisements to be presented by indicating one or more of:
a time window;
a time of day;
a day of week;
a weather condition;
a range of location; and
an activity.

11. The computer-readable medium of claim 8, wherein managing the auction size comprises:
increasing the auction size when the number of participants in the auction is below a predetermined lower limit; or
reducing the auction size when the number of participants in the auction is greater than a predetermined upper limit.

12. The computer-readable medium of claim 8, wherein managing the auction size comprises increasing the auction size by performing one or more of the following operations to the auction criteria:
increasing the size of a time window;
increasing a range of location; and
dropping a constraint from the criteria.

13. The computer-readable medium of claim 8, wherein managing the auction size comprises reducing the auction size by performing one or more of the following operations to the auction criteria:
reducing the size of a time window;
reducing a range of location; and
adding a constraint from the criteria.

14. The computer-readable medium of claim 8, further comprising modifying the auction criteria based on the presentation preferences specified in a bid.

15. A computer system that facilitates managing auction size in an activity-based advertising system, the computer system comprising:
a processor;
a memory coupled to the processor;
a topic-identification mechanism configured to identify a topic;
an auction-criteria determination mechanism configured to determine a set of auction criteria associated with the topic;
an auction-hosting mechanism configured to host an auction for advertisements pertaining to the topic;
a bid-receiving mechanism configured to receive a number of bids in response to the auction, wherein a respective bid is associated with an advertisement and a set of presentation preferences, and wherein a respective bid satisfies the auction criteria;
an auction-size-management mechanism configured to determine the quality of auction size and to manage the auction size by modifying the auction criteria; and
a presentation mechanism configured to present the advertisements based on the winning bids.

16. The computer system of claim 15, wherein while determining the quality of auction size, the auction-size-management mechanism is configured to perform one or more of:
determining the number of participants in the auction;
determining the consistency of participation in the auction;
determining the distribution of bids with respect to each bid's presentation preference and the auction criteria; and
determining the number of repeated participations of the a winning bidder.

17. The computer system of claim 15, wherein the auction criteria specify the constraints on the advertisements to be presented by indicating one or more of:
a time window;
a time of day;
a day of week;
a weather condition;
a range of location; and
an activity.

18. The computer system of claim 15, wherein while managing the auction size, the auction-size-management mechanism is configured to:
increase the auction size when the number of participants in the auction is below a predetermined lower limit; or
reduce the auction size when the number of participants in the auction is greater than a predetermined upper limit.

19. The computer system of claim 15, wherein while managing the auction size, the auction-size-management mechanism is configured to increase the auction size by performing one or more of the following operations to the auction criteria:
increasing the size of a time window;
increasing a range of location; and
dropping a constraint from the criteria.

20. The computer system of claim 15, wherein while managing the auction size, the auction-size-management mechanism is configured to reduce the auction size by performing one or more of the following operations to the auction criteria:
reducing the size of a time window;
reducing a range of location; and
adding a constraint from the criteria.

21. The computer system of claim 15, wherein the auction-size-management mechanism is further configured to modify the auction criteria based on the presentation preferences specified in a bid.
